(19) United States
(12) Patent Application Publication
(10) Pub. No.: US 2014/0254082 A1
(43) Pub. Date: Sep. 11, 2014

(54) ELECTRONIC DEVICE HAVING MOVABLE SCREEN

(71) Applicant: HON HAI PRECISION INDUSTRY CO., LTD., New Taipei (TW)

(72) Inventors: KUAN-YU LIN, New Taipei (TW); HSUAN-YU LIN, New Taipei (TW); LI-CHE LU, New Taipei (TW)

(73) Assignee: HON HAI PRECISION INDUSTRY CO., LTD., New Taipei (TW)

(21) Appl. No.: 14/196,016

(22) Filed: Mar. 4, 2014

(30) Foreign Application Priority Data
Mar. 7, 2013 (TW) 102107967

(51) Int. Cl. G06F 1/16

(52) U.S. Cl. CPC G06F 1/1681
USPC 361/679.27

(57) ABSTRACT

An electronic device includes a base and a cover. The base includes a sliding member slidably mounted thereon. The cover includes a touch screen. The cover is pivotally mounted on the sliding member. The cover is rotated to be substantially parallel to the base. The sliding member slides along the base to slide the cover along the base.

### FIELD

The disclosure generally relates to electronic devices, and more particularly to an electronic device having a movable screen.

### BACKGROUND

Electronic devices, such as notebook computers, are widely used. The notebook computer often includes a base and a screen rotatably mounted on the base via a rotating structure. To use the notebook computer, the screen rotates relative to the base to an open position. The screen may be a touch screen. However, because the touch screen is pivotally mounted on the base, it may be inconvenient to use the touch screen to input information.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an electronic device.

FIG. 2 is an enlarged view of a circled portion II of FIG. 1.

FIG. 3 is an enlarged view of a circle portion III of FIG. 2.

FIG. 4 is an enlarged view of a sliding member of the electronic device of FIG. 1.

FIG. 5 is an assembled view of the electronic device of FIG. 1.

FIG. 6 is another assembled view of the electronic device of FIG. 1.

FIG. 7 is another assembled view of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

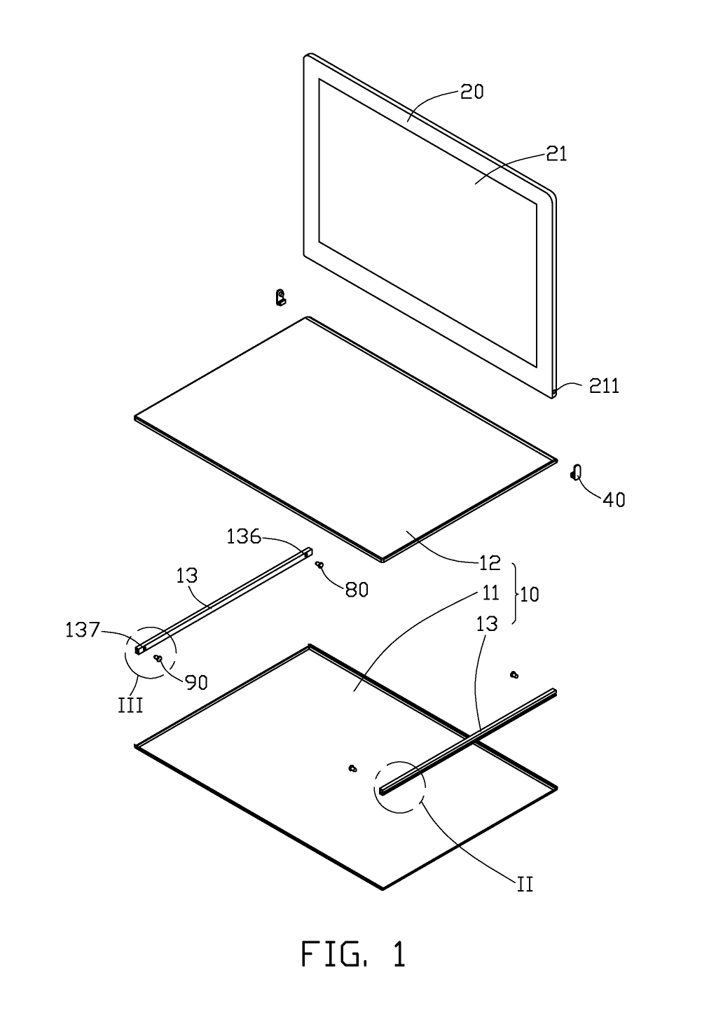

FIG. 1 shows one embodiment of an electronic device. The electronic device includes a base 10 and a cover 20. The cover 20 includes a screen 21. In one embodiment, the screen 21 is a touch screen.

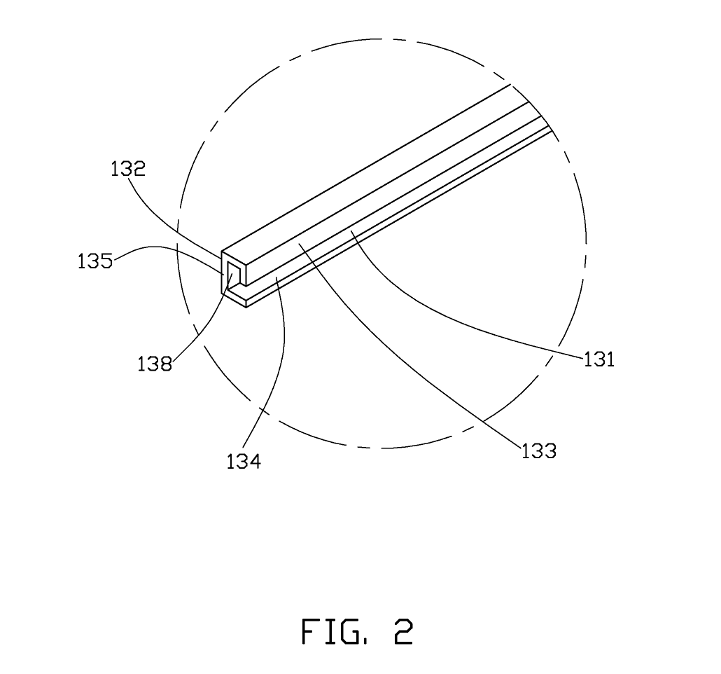

Referring to FIGS. 1 and 2, the base 10 includes a bottom plate 11, a seat 12, and two slide rails 13. The seat 12 can be mounted on the bottom plate 11. The two slide rails 13 are mounted on two opposite edges of the seat 12. The slide rail 13 includes a first side 131 and a second side 132. A restricting strip 133 is set on the first side 131 of the slide rail 13. An opening 134 is defined below the restricting strip 133. A mounting wall 135 is set on the second side 132 of the slide rail 13. A first positioning hole 136 and a second positioning hole 137 are defined in the mounting wall 135. A slide way 138 is defined between the first side 131 and the second side 132.

A first positioning pillar 80 can be mountably received in the first positioning hole 136. A second positioning pillar 90 can be mountably received in the second positioning hole 137.

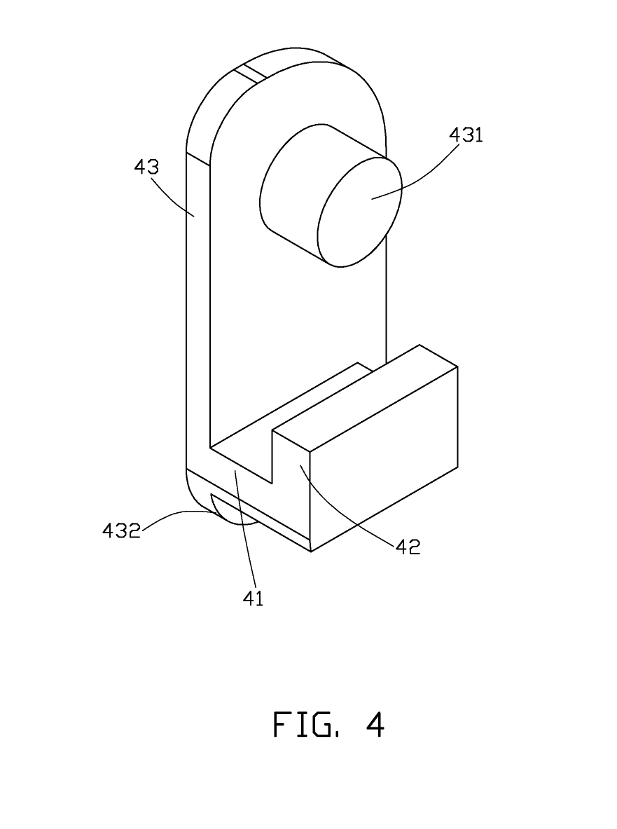

Referring to FIGS. 1 and 4, each slide rail 13 can slidably receive a sliding member 40 therein. The sliding member 40 includes a connecting piece 41, a restricting piece 42, and a mounting piece 43. The restricting piece 42 and the mounting piece 43 are connected substantially perpendicularly to opposite edges of the connecting piece 41. The restricting piece 42 is substantially parallel to the mounting piece 43. A height of the restricting piece 42 is larger than a height of the opening 134. A pivot pin 431 is formed on the mounting piece 43. A bottom of the mounting piece 43 forms an arced sliding surface 432.

The cover 20 defines a pair of pivot holes 201.

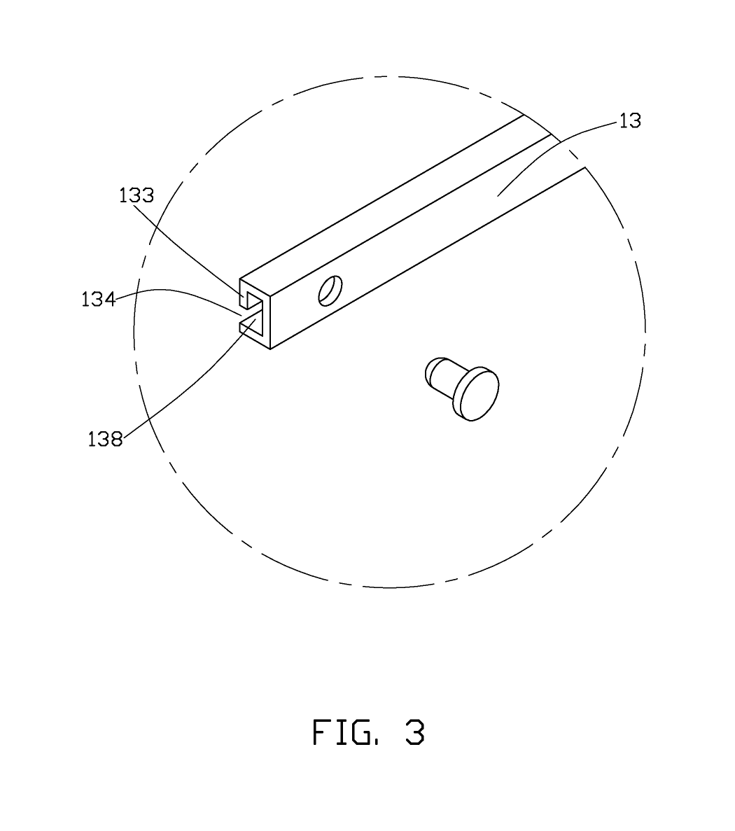

Referring to FIGS. 1 through 5, in assembly, the restricting pieces 42 of the sliding members 40 are slidably received in the slide ways 138 of the corresponding slide rails 13. The restricting piece 42 abuts the restricting strip 133 to be prevented from moving out of the slide way 138. The sliding members 40 are located at a side of the first positioning pillars 80 toward a first end of the slide rails 13. The slide rails 13 are mounted on the seat 12, and the seat 12 is mounted on the bottom plate 11. The pivot pins 431 of the sliding members 40 are pivotally received in the corresponding pivot holes 201 of the cover 20. Therefore, the electronic device is assembled.

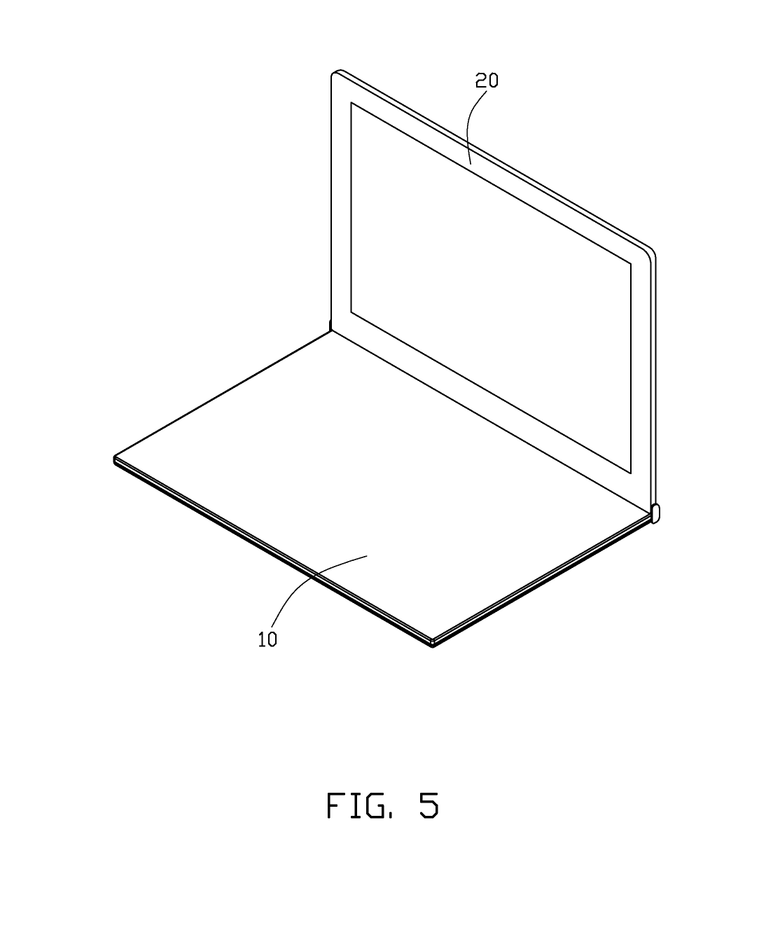

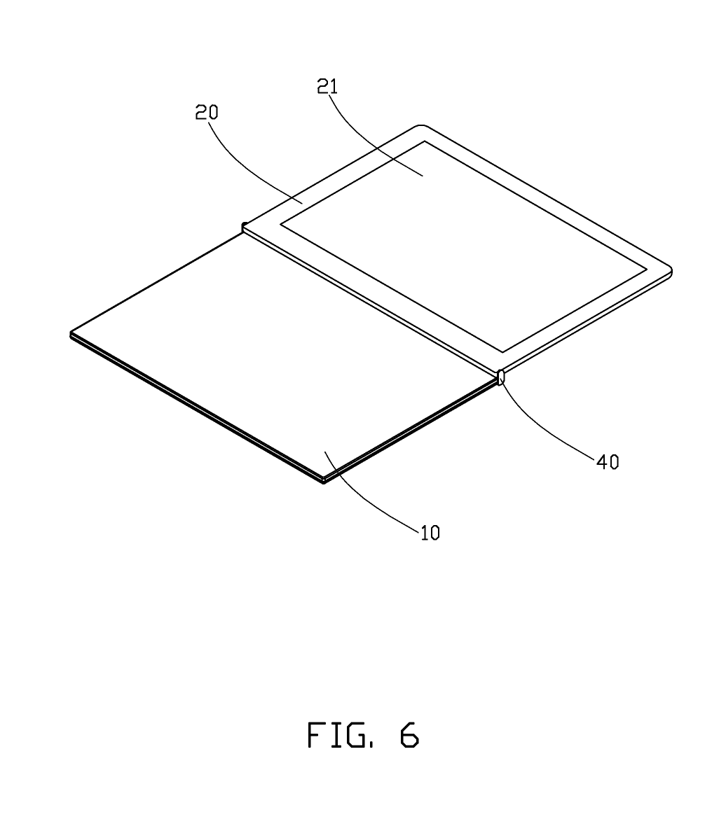

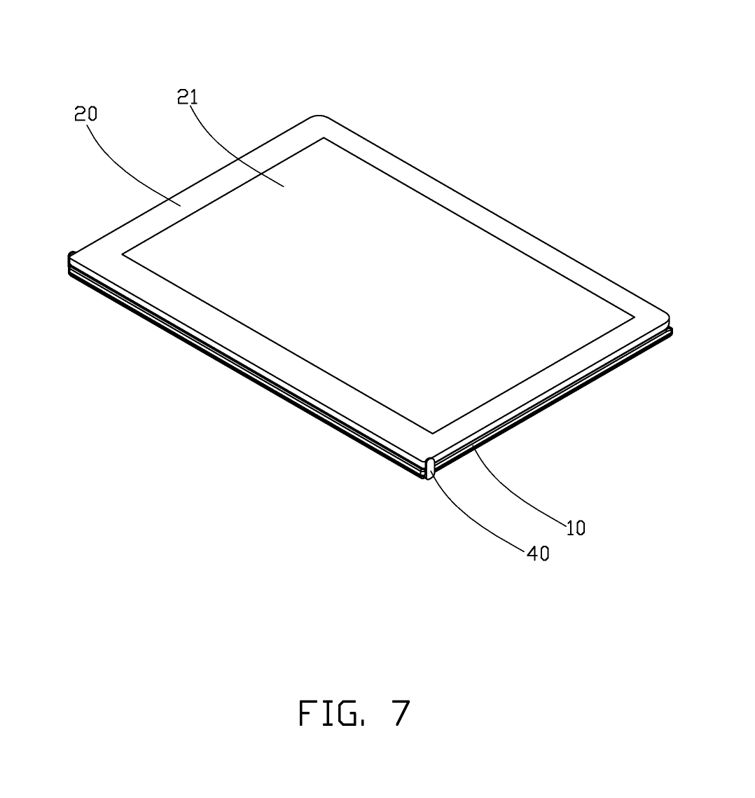

In use, referring to FIG. 5, the cover 20 is rotated on the base 10 to expose the screen 21. Thus, information can be input to the screen 21 by a keyboard (not shown) mounted on the base 10. Referring to FIGS. 6 and 7, to input information to the screen 21 by touching the screen 21, the cover 20 is rotated to be substantially parallel to the base 10. Then, the sliding members 40 slide over the first positioning pillars 80 and slide along the slide rails 13, until the sliding members 40 abut the second positioning pillars 90. Therefore, it is convenient to touch the screen 21 to input information.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic device, comprising:
a base comprising a sliding member slidably mounted thereon; and
a cover pivotally mounted on the sliding member, the cover being configured to accommodate at least one flat screen;
wherein the cover can be rotated on the sliding member to be parallel to the base, and the cover is configured to fold over the base by sliding the sliding member on the base.

2. The electronic device of claim 1, wherein a slide rail is mounted on the base, and the sliding member is slidably received in the slide rail.

3. The electronic device of claim 2, wherein a restricting strip is located on a first side of the slide rail, an opening is defined below the restricting strip, the sliding member comprises a restricting piece and a connecting piece, the restricting piece is located in the slide rail and abuts the restricting piece, and the connecting piece is slidable in the opening.

4. The electronic device of claim 3, wherein a slide way is defined between the first side and a second side of the slide rail, and the restricting piece is located in the slide way.

5. The electronic device of claim 4, wherein a mounting wall is formed on the second side, the mounting wall defines a first positioning hole and a second positioning hole, a first positioning pillar is mounted in the first positioning hole, a second positioning pillar is mounted in the second positioning hole, and each of the first positioning pillar and the second positioning pillar is configured to block the sliding member from sliding in the slide rail.

6. The electronic device of claim 3, wherein the sliding member comprises a mounting piece, the mounting piece comprises a pivot pin, and the cover defines a pivot hole, and the pivot pin is pivotally inserted into the pivot hole.

7. The electronic device of claim 6, wherein the mounting piece and the restricting piece are perpendicularly connected to opposite edges of the connecting piece.

8. An electronic device, comprising:
a base comprising a first positioning pillar and a second positioning pillar, a sliding member slidably mounted on the base and configured to slide between the first positioning pillar and the second position pillar; and
a cover slidably mounted on the sliding member, the cover being configured to accommodate at least one flat screen;
wherein the cover is configured to rotate on the sliding member to be parallel to the base, and the at least one screen is exposed by sliding the sliding member over the base and by folding the cover over the base.

9. The electronic device of claim 8, wherein a slide rail is mounted on the base, and the sliding member is slidably received in the slide rail.

10. The electronic device of claim 9, wherein a restricting strip is located on a first side of the slide rail, an opening is defined below the restricting strip, the sliding member comprises a restricting piece and a connecting piece, the restricting piece is located in the slide rail and abuts the restricting piece, and the connecting piece is slidable in the opening.

11. The electronic device of claim 10, wherein a slide way is defined between the first side and a second side of the slide rail, and the restricting piece is located in the slide way.

12. The electronic device of claim 11, wherein a mounting wall is formed on the second side, the mounting wall defines a first positioning hole and a second positioning hole, the first positioning pillar is mounted in the first positioning hole, and the second positioning pillar is mounted in the second positioning hole.

13. The electronic device of claim 8, wherein the sliding member comprises a mounting piece, the mounting piece comprises a pivot pin, and the cover defines a pivot hole, and the pivot pin is pivotally inserted into the pivot hole.
